(19) United States
(12) Patent Application Publication
(10) Pub. No.: US 2022/0174246 A1
(43) Pub. Date: Jun. 2, 2022

(54) PROJECTION SYSTEM AND METHODS

(71) Applicant: Applied Materials, Inc., Santa Clara, CA (US)

(72) Inventors: Christopher Dennis BENCHER, Santa Clara, CA (US); David MARKLE, Pleasanton, CA (US)

(21) Appl. No.: 17/109,581

(22) Filed: Dec. 2, 2020

(51) Int. Cl. H04N 9/31

(52) U.S. Cl. CPC H04N 9/3152; H04N 9/3155; H04N 9/3185; H04N 9/3164; H04N 9/3158

(57) ABSTRACT

Examples described herein provide a projection system, and a software application and a method related thereto. A system includes a pixelated light source and an optical relay. The pixelated light source includes an array of spatial light modulator pixels. Each spatial light modulator pixel being individually controllable to selectively project a beam of light. The optical relay includes an optically reflective surface and an actuator coupled to the optically reflective surface. The actuator is configured to move the optically reflective surface. The pixelated light source and the optical relay are configured such that one or more beams projected from the pixelated light source are reflected off of the optically reflective surface and form an image of the optical relay in a focal plane. Movement of the optically reflective surface causes the respective beams to be at varying locations in the focal plane.

### BACKGROUND

### Field

Examples of the present disclosure generally relate to projection systems and methods. More particularly, examples of the present disclosure relate to a projection system, and a software application and/or a method of projecting an image.

### Description of the Related Art

Projection systems used to project an image have been used in a number of applications. For example, movie theaters commonly use video projectors to project a sequence of images on a screen. Lithography can use a projection system to expose photosensitive material to an image to thereby pattern the photosensitive material. More recently, three-dimensional (3D) printing can use a projection system to project an image of each slice of the object being printed in some photosensitive liquid. The characteristics of projection systems used in these examples can vary depending on the requirements of the application.

### SUMMARY

In some examples, a system is provided. The system includes a pixelated light source and an optical relay. The pixelated light source includes an array of spatial light modulator pixels. Each spatial light modulator pixel is individually controllable to selectively project a beam of light. The optical relay includes an optically reflective surface and an actuator coupled to the optically reflective surface. The actuator is configured to move the optically reflective surface. The pixelated light source and the optical relay are configured such that one or more beams projected from the pixelated light source are reflected off of the optically reflective surface and form an image of the optical relay in a focal plane. Movement of the optically reflective surface causes the respective beams to be at varying locations in the focal plane.

In other examples, a method is provided. A convex optically reflective surface is moved. One or more beams are projected from a pixelated light source based on a position of the convex optically reflective surface. The one or more beams are reflected off of the convex optically reflective surface towards a target. Movement of the convex optically reflective surface varies respective one or more angles of reflection of the one or more beams reflected off of the convex optically reflective surface.

In yet other examples, a non-transitory storage medium stores instructions. When the instructions are executed by a processor, the execution causes the processor to perform operations comprising: controlling movement of an actuator, the actuator being connected to a convex optically reflective surface; receiving positional information of the convex optically reflective surface from an encoder; and controlling a pixelated light source to selectively project one or more beams based on the positional information. The one or more beams are incident on the convex optically reflective surface. Movement of the convex optically reflective surface varies respective one or more angles of reflection of the one or more beams reflected off of the convex optically reflective surface.

### BRIEF DESCRIPTION OF THE DRAWINGS

So that the manner in which the above recited features of the present disclosure can be understood in detail, a more particular description of the disclosure, briefly summarized above, may be had by reference to described examples, some of which are illustrated in the appended drawings. It is to be noted, however, that the appended drawings illustrate only examples and are therefore not to be considered limiting of its scope, and may admit to other equally effective implementations.

FIG. 1 is a perspective view of a projection system that may be implemented in some examples.

FIG. 2 shows aspects of how beams can be incident at different locations in an image of a relay according to some examples.

FIG. 3 shows a simplified array of path centers, variable placement beam centroids, and paths according to some examples.

FIG. 4 shows a graph of wavefront errors at an image of a relay for beams having different wavelengths of light according to some examples.

FIG. 5 illustrates aspects of an instantaneous exposure by a beam according to some examples.

FIG. 6 is a flowchart of a method for generating an image in an image of a relay according to some examples.

FIGS. 7A and 7B show exposure locations along a path and an address grid resulting from the exposure locations according to some examples.

FIGS. 8A and 8B show exposure locations along a path and an address grid resulting from the exposure locations according to some examples.

FIGS. 9A and 9B show exposure locations along a path and an address grid resulting from the exposure locations according to some examples.

FIGS. 10A and 10B show exposure locations along a path and an address grid resulting from the exposure locations according to some examples.

FIGS. 11A, 11B, 110, and 11D show which spatial light modulator pixels are to be turned on and turned off at respective rotational positions of the convex reflective surface in binary imaging according to some examples.

FIGS. 12A, 12B, 12C, and 12D show which spatial light modulator pixels are to be turned on and turned off at respective rotational positions of the convex reflective surface in greyscale imaging according to some examples.

FIGS. 13A, 13B, and 13C show greyscale polygons of an image and which spatial light modulator pixels are to be turned on and turned off at respective rotational positions of the convex reflective surface in greyscale imaging according to some examples.

FIG. 14 shows aspects of sub-pixel edge control using greyscale imaging according to some examples.

FIG. 15 shows aspects of sub-pixel edge control using a sub-pixel address grid according to some examples.

FIGS. 16A, 16B, and 16C show exposure locations along a path, a pattern of paths, and an address grid resulting from the exposure locations and pattern of paths according to some examples.

FIG. 17 is a graph showing error of edge placement according to some examples.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

Examples described herein provide a projection system, and a software application and/or a method of projecting an image. The projection system can be static relative to the surface or substrate on which the image is projected. The projection system can include a convex reflective surface that is rotated off-axis in a way that beams of light projected onto the convex reflective surface are reflected to varying locations. The varying locations can be along a path, e.g., respective circular paths, and the locations can form an address grid that is used to form one or more bitmaps used to project the image. In some examples, the address grid and operation of the projection system can permit redundancy, binary and/or greyscale imaging, imaging with different wavelengths of light, sub-pixel edge control, and/or other benefits.

Various different examples are described below. Although multiple features of different examples may be described together in a process flow or system, the multiple features can each be implemented separately or individually and/or in a different process flow or different system. Additionally, various process flows or operations are described as being performed in an order; other examples can implement process flows or operations in different orders and/or with more or fewer operations.

Projection System

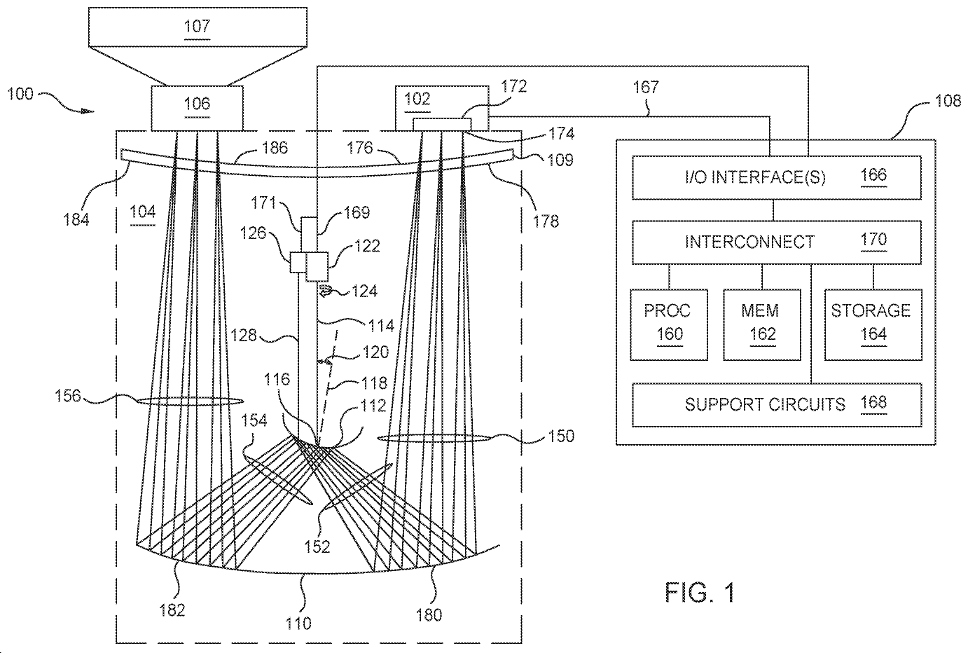

FIG. 1 is a perspective view of a projection system 100 that may be implemented in some examples. The projection system 100 includes a pixelated light source 102, a relay 104, a projection lens 106, a substrate 107, and a controller 108. The projection system 100 is configured to project an image incident on the substrate 107.

The pixelated light source 102 includes an array of spatial light modulators. Each spatial light modulator may be referred to as a pixel, and hence, the pixelated light source 102 can be said to include an array of pixels. The array of spatial light modulators includes, but are not limited to, digital micromirrors, liquid crystal displays (LCDs), liquid crystal over silicon (LCoS) devices, an array of light emitting diodes, an array of vertical cavity surface-emitting laser (VCSEL) devices, ferroelectric liquid crystal on silicon (FLCoS) devices, and microshutters. Each spatial light modulator is individually controllable and is configured to selectively project a beam. The pixelated light source 102 can include one or more discrete devices that can collectively form the array of spatial light modulators. The size of the array of spatial light modulators (e.g., the number of pixels) may vary based on the size and resolution of the image to be projected incident on the substrate 107, for example. In some examples, the pixelated light source 102 is or includes a digital micromirror device (DMD) having an array of spatial light modulators that is of a given size, e.g., 1080×1920.

The relay 104 includes a lens 109, a concave reflective surface 110, and a convex reflective surface 112. The relay 104 has an object of the relay, which in this example, is the light source 102, and has an image of the relay, which in this example, is an object plane of the projection lens 106. The image of the relay in this example is also an intermediate focal plane. The image of the relay can be directed at a target, which in this example is the projection lens 106 or other lens, and in other examples, can be the substrate 107 (e.g., without a lens or other optics intervening between the relay 104 and the substrate 107). The lens 109 of the relay 104 may be any appropriately shaped transparent material, such as a glass lens. The concave reflective surface 110 and the convex reflective surface 112 may each be a mirror. In some examples, the relay 104 is an Offner relay. The lens 109 and concave reflective surface 110 can be physically mounted to, e.g., a housing of the relay 104 to maintain distances and operability of the relay 104 as described herein. The dimensions and shapes of the lens 109, concave reflective surface 110, and convex reflective surface 112 can be determined based on various considerations of the projection system 100, including aspects described herein, form factors, focal points, etc. In some examples, the convex reflective surface 112 can have a shape corresponding to a portion of an ellipsoid. In some examples, the convex reflective surface 112 can have a non-uniform radius of curvature.

The convex reflective surface 112 is attached to an axle 114 at a connection point 116 on a backside of the convex reflective surface 112. An axis 118 is normal to a tangential surface of the convex reflective surface 112 at the connection point 116. The axle 114 is at a non-zero angle 120 to the axis 118 (e.g., also referred to herein as “off axis”). In some examples, the connection point 116 is a center of mass of the convex reflective surface 112 along directions perpendicular to the axle 114.

An actuator 122 (e.g., a motor) is attached to the axle 114. The actuator 122 can be physically mounted to, e.g., the housing of the relay 104 like the lens 109 and concave reflective surface 110. The actuator 122 is configured to rotate 124 the axle 114. Rotation 124 of the axle 114 causes the convex reflective surface 112 to rotate around the connection point 116. If the connection point 116 is a center of mass along directions perpendicular to the axle 114, vibrations caused by the rotation 124 of the axle 114 and convex reflective surface 112 can be reduced or avoided. In some examples, the actuator 122 is configured to continuously rotate the axle 114 when the actuator 122 is driving the rotation, while in other examples, the actuator 122 is configured for step-wise rotation of the axle 114 when the actuator 122 is driving the rotation.

An encoder 126 is positioned, in the illustrated example, to view the backside of the convex reflective surface 112 and determine a rotational position of the convex reflective surface 112. As illustrated, the encoder 126 is disposed on the actuator 122 and is positioned with a view 128 of the backside of the convex reflective surface 112. The encoder 126 can be positioned differently in other examples. Notches or other identifying marks can be formed in or on the backside of the convex reflective surface 112. The encoder 126 can view the notches or identifying marks and process the view to determine the rotational position of the convex reflective surface 112 at any given instance. In other examples, the encoder 126 can be positioned to view a side of the axle 114 or a lateral edge of the convex reflective surface 112, where, in such examples, the side of the axle 114 or lateral edge of the convex reflective surface 112 has notches or other identifying marks, respectively.

The controller 108 includes a processor 160, memory 162, storage 164, input/output (I/O) interfaces 166, support circuits 168, and an interconnect 170. Each of the processor 160, memory 162, storage 164, I/O interfaces 166, support circuits 168 is connected to the interconnect 170. The I/O interfaces 166 are communicatively coupled to the pixelated light source 102 via a first data path 167, the actuator 122 via a second data path 169, the encoder 126 via a feedback path 171, and any other I/O devices (not illustrated) (for example, keyboard, display, touchscreen, and mouse devices). The first data path 167, second data path 169, and feedback path 171 are described and illustrated as separate, although in some examples, these paths may be or may be considered a same data path.

The processor 160 is configured to retrieve and execute instruction code stored in the memory 162 and/or storage 164. The processor 160 may be one of any form of processors, such as a general purpose processor, a central processing unit (CPU), a graphics processing unit (GPU), or the like. The processor 160 is included to be representative of a single CPU, multiple CPUs, a single CPU having multiple processing cores, etc.

The instruction code includes a projection control application. The projection control application, when executed by the processor 160, causes the processor 160 to control the actuator 122 via the second data path 169 and the pixelated light source 102 via the first data path 167 and to receive positional information from the encoder 126 via the feedback path 171. The projection control application can be based on application data, such as a bitmap file described in further detail below. The instruction code can further include a generation application that, when executed by the processor, generates application data on which the projection control application operates (e.g., a bitmap file) from another form of application data (e.g., another image file). Similarly, the processor 160 may be configured to cause the application data to be stored in the memory 162 and to retrieve the application data stored in the memory 162.

The processor 160 can control the pixelated light source 102 and actuator 122 via communications via the interconnect 170, I/O interfaces 166, and data paths 167, 169 and/or may receive data from the encoder 126 via communications via the interconnect 170, I/O interfaces 166, and feedback path 171. The interconnect 170 is operable to transmit instruction code and application data between the processor 160, I/O interfaces 166, storage 164, and memory 162.

The memory 162 is generally included to be representative of any non-transitory memory (e.g., random access memory (RAM) (like static RAM and dynamic RAM), read-only memory (ROM), etc.), which may be volatile and/or non-volatile, and, in operation, is operable to store one or more software applications and data for use by the processor 160. Storage 164 is generally included to be representative of any non-transitory, non-volatile memory, such as a hard disk drive, solid-state storage drive (SSD), etc. Although shown as a single unit, the storage 164 may be a combination of fixed and/or removable storage devices, such as fixed disk drives, floppy disk drives, hard disk drives, flash memory storage drives, tape drives, removable memory cards, CD-ROM, optical storage, etc. configured to store non-volatile data. The memory 162 may store instruction code (e.g., as described above) that is capable of being executed by the processor 160. In some examples, the instruction code may additionally and/or alternatively be stored in the storage 164.

The support circuits 168 are also connected to the interconnect 170 for supporting the processor 160 and/or are connected to other components for support thereof. The support circuits 168 may include a cache, power supplies, clock circuits, input/output circuitry, and the like.

The controller 108 can cause the actuator 122 to start, continue, and stop rotation of the axle 114 and convex reflective surface 112. The controller 108 can receive positional information from the encoder 126 relating to the rotational position of the convex reflective surface 112. The controller 108 can control the pixelated light source 102 to project light from various spatial light modulator pixels. The controller 108 can control which spatial light modulator pixels project light and when, which may be based on the positional information from the encoder 126.

Before describing the operation of the projection system 100 of FIG. 1 in further detail, additional description of the pixelated light source 102 is provided. The pixelated light source includes an array of the spatial light modulators, as stated previously. The spatial light modulator pixel assembly of the pixelated light source 102 includes a light source, an aperture, a lens, a frustrated prism assembly or mirror, a spatial light modulator pixel, a light dump, and a projection lens. In other examples, an image projection system may include different or fewer components.

When the pixelated light source 102 is self-emitting, such as a pixelated light emitting diode (LED) array or a pixelated VCSEL array, the wavelength of the light of the pixelated light source 102 can be selected based on the application. For example, the wavelength(s) may be red, green, or blue when using multiple LED and multiple relays in a theatre application, or red, green, and blue when using a single self-emissive pixelated light source 102 and single relay in a theatre application. As another example, the wavelength may be less than 450 nm, such as near ultraviolet, for photo-lithography or 3D printing applications. When the pixelated light source 102 includes a reflective device (such as a DMD or LCoS) or a shutter device, then an illuminator may be implemented to illuminate the pixelated light source 102, whereas the light source may be a LED or a laser, and the light source may be capable of producing a light having a predetermined wavelength. In some examples, the light source can have a wavelength of red, green, or blue visible light or can have multiple wavelengths of light, such as red, green, and blue light. In some examples, the predetermined wavelength is in the blue or near ultraviolet (UV) range, such as less than about 450 nm. The wavelength of the light generated by the light source can be based on the application of the projection system 100, such as dependent on a response to a photosensitive material in lithography or 3D printing or on visible light to be projected in a movie theater. The illuminator may be configured to focus the beam generated by the light source, and passed through the aperture and lens, onto the spatial light modulator pixel. The projection lens 106 following the relay 104 may have any magnification suitable for the given application.

In operation, based on control by the controller 108, each spatial light modulator pixel is at an “on” position or “off” position. During operation, a beam is produced by the light source and is directed, through the illuminator containing an aperture and lens, to the pixelated light source 102. In some cases, optical design and/or form factor compaction may require a prism assembly or mirror. The beam is directed from and focused by the illuminator to the spatial light modulator pixel of the spatial light modulator pixel assembly. When the beam reaches the spatial light modulator pixel, the spatial light modulator pixel in an “on” position reflects the beam through the relay 104 and subsequently through the projection lens 106. As used herein, a beam projected from the pixelated light source 102 of a limited duration may also be referred to as a “shot.” The spatial light modulator pixels that are at an “off” position reflect the beam to the light dump instead projecting the beam from the pixelated light source 102.

In some examples, a spatial light modulator pixel assembly is part of a digital micromirrors device (DMD) that includes mirrors, which are the spatial light modulator pixels. In some examples, the DMD includes 1920×1080 mirrors. In some examples, the DMD includes more than about 4,000,000 mirrors.

One or more beams 150 can be projected from the pixelated light source 102 (e.g., from the object of the relay). In the illustrated example, the pixelated light source 102 also includes a transparent material through which the one or more beams 150 are projected. The transparent material can be, e.g., part of a protective housing of the pixelated light source 102 and can be glass. The transparent material has an interior surface 172 (e.g., interior to the housing) and an exterior surface 174. The one or more beams 150 are projected through the transparent material in a direction such that the one or more beams 150 are incident on the interior surface 172 and are subsequently incident on the exterior surface 174. The beams 150 are then passed through the lens 109. The lens 109 has a first surface 176 on which the beams 150 are incident and a second surface 178 on which the beams 150 are subsequently incident.

The beams 150 are incident on and reflected from a first surface 180 of the concave reflective surface 110 towards the convex reflective surface 112 as beams 152. The beams 152 are incident on and reflected from the convex reflective surface 112 towards the concave reflective surface 110 as beams 154. The beams 154 are incident on and reflected from a second surface 182 of the concave reflective surface 110 towards the projection lens 106 as beams 156. It is noted that the first surface 180 and second surface 182 may be a same surface but are identified separately for ease of subsequent description. The beams 156 are then passed through the lens 109. The lens 109 has a first surface 184 on which the beams 156 are incident and a second surface 186 on which the beams 156 are subsequently incident. It is noted that the first surface 176 and second surface 186 may be a same surface, and that the second surface 178 and first surface 184 may be a same surface. These surfaces are identified separately for ease of subsequent description. The beams 156 are then incident on the projection lens 106, in which an intermediate focal plane is disposed. This intermediate focal plane is also the image of the relay and object of the projection lens 106. The image of the relay can be a 1× magnification of the object of the relay in some examples.

The image of the relay is then projected by the projection lens 106 onto the substrate 107 as an image of the projection lens. The projection lens 106 can magnify or shrink the image of the relay to the image of the projection lens. For example, for a lithography process, the image of the relay can be shrunk to the image of the projection lens (e.g., which shrinks a pixel size), and the projection lens 106 can have a magnification of less than 1, and more particularly, can have a magnification in a range from 0.2× to 0.5×. For a 3D printing, the image of the relay can be maintained or increased in size to the image of the projection lens, and the projection lens 106 can have a magnification of equal to or greater than 1, and more particularly, can have a magnification that is greater than 10×, e.g., to enable part sizes 10× larger than the light source 102. For a theater application, the image of the relay can be increased in size to the image of the projection lens, and the projection lens 106 can have a magnification of equal to or greater than 1, and more particularly, can have a magnification that is greater than 50× (e.g., in a range from 50× to 500×), e.g., for magnifying an image onto a large screen. The relay 104 can magnify, maintain a same image size, or shrink the object of the relay (e.g., from the light source 102) to be the image of the relay.

Various spatial light modulator pixels can be turned on and off during operation (e.g., at the direction of the controller 108) to project the beams 150. Further, the convex reflective surface 112 can be rotated by the actuator 122 rotating 124 the axle 114 (e.g., at the direction of the controller 108) during operation. The pixelated light source 102, lens 109, concave reflective surface 110, and projection lens 106 can remain static or unmoving during operation. More generally, the projection system 100 can remain static or unmoving relative to the image projected at the substrate 107 (e.g., a photosensitive material in 3D printing or lithography, or a screen surface in a movie theater).

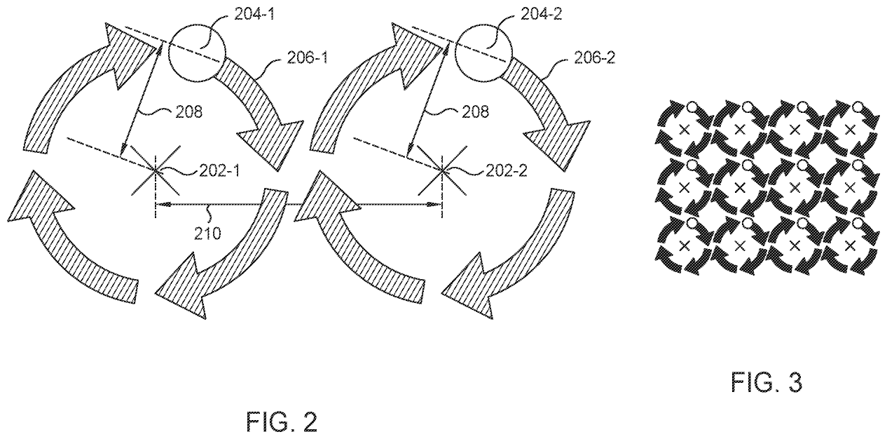

Rotation of the convex reflective surface 112 can permit beams 154 to be incident on different locations on the concave reflective surface 110 and, thereby, beams 156 to be incident at different locations in the image of the relay (e.g., in the intermediate focal plane). FIG. 2 illustrates aspects of how beams can be incident at different locations in the image of the relay, for example. Path centers 202-1, 202-2 are shown. The path centers 202-1, 202-2 in FIG. 2 can correspond to where respective beams 156 generated by neighboring spatial light modulator pixels projecting corresponding beams 150 may be incident in the image of the relay if, e.g., the convex reflective surface 112 was attached to the axle 114 at the connection point 116, the axle 114 was on the axis 118, and the convex reflective surface 112 did not move. Variable placement beam centroids 204-1, 204-2 are shown. The variable placement beam centroids 204-1, 204-2 are centroids of respective beams 156 generated by neighboring spatial light modulator pixels projecting corresponding beams 150. The variable placement beam centroids 204-1, 204-2 can be along any location of respective paths 206-1, 206-2 due to the rotation of the convex reflective surface 112. The convex reflective surface 112 being attached off axis can cause the angle of incidence of the beams 152 to change during rotation of the convex reflective surface 112, which results in the angle of reflection of the beams 154 to change. These changes in angles result in the variable placement beam centroids 204-1, 204-2 to be able to follow the respective paths 206-1, 206-2.

The paths 206-1, 206-2 are generally circular and encircle the respective path centers 202-1, 202-2. In some examples, some distortion between pixels and distortion of an individual path may occur due to changes of angles of incidence possibly being non-uniform resulting from geometries of various reflective surfaces. Small offsets can maintain low distortions and low levels of wavefront errors. For example, for a 20 mm sized DMD, with 2560×1600 pixels, the image field can be displaced by up to 10 pixels without significant distortion.

The paths 206-1, 206-2 form respective radii 208 from the path centers 202-1, 202-2, which are also half a diameter of the paths 206-1, 206-2. A pitch 210 is between path centers 202-1, 202-2. The radii 208 for the beams can generally be equal, with some differences due to possible distortion noted previously. The variable placement beam centroids 204-1, 204-2 can move in parallel along the paths 206-1, 206-2 such that the pitch 210 is maintained along the paths 206-1, 206-2 at any given instance. Any path 206-1, 206-2 can encircle any number of other path centers (e.g., radii 208 of the paths 206-1, 206-1 can be greater than a pitch 210 between path centers 202-1, 202-2). A ratio (r/P) of the radius 208 to the pitch 210 can affect various patterns of paths of beams, some of which are illustrated and described below.

FIG. 3 shows a simplified array of path centers, variable placement beam centroids, and paths. The array is 3 rows×4 columns as an example.

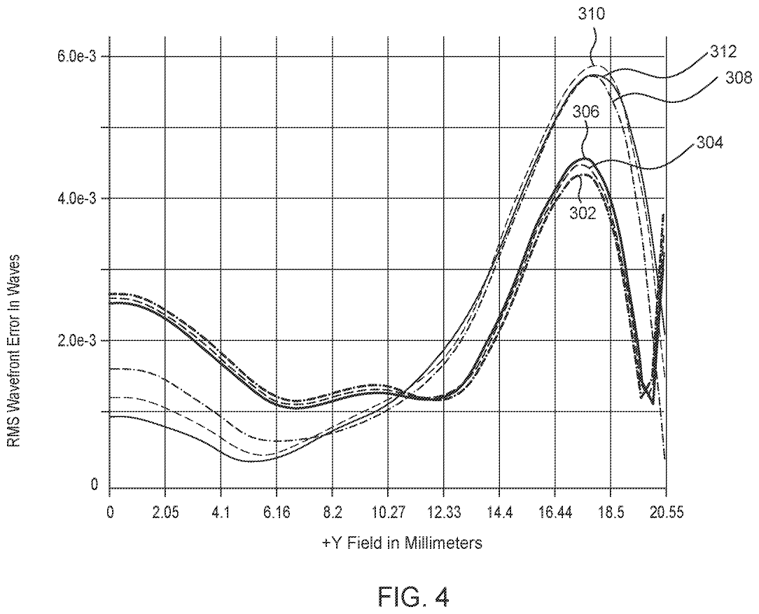

FIG. 4 shows a graph of wavefront errors at an image of the relay for beams having different wavelengths of light according to some examples. Wavefront error 302 is for a beam having a wavelength of 399 nm. Wavefront error 304 is for a beam having a wavelength of 403 nm. Wavefront error 306 is for a beam having a wavelength of 407 nm. Wavefront error 308 is for a beam having a wavelength of 500 nm. Wavefront error 310 is for a beam having a wavelength of 575 nm. Wavefront error 312 is for a beam having a wavelength of 650 nm. FIG. 4 shows that excellent aberration control can be obtained for wavelengths from 400 nm (e.g., for lithography and 3D printing) through 650 nm (e.g., which range can permit use as red, green, and blue light for a theater application.

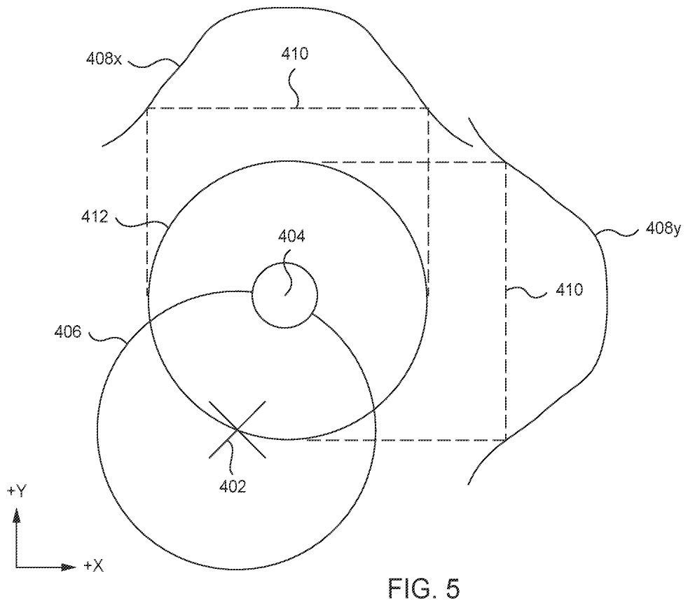

FIG. 5 illustrates aspects of an instantaneous exposure by a beam. FIG. 5 shows a path center 402, a variable placement beam centroid 404, and a path 406, similar to FIG. 2. When the beam is incident on, e.g., the substrate 107 with the variable placement beam centroid 404 located as shown, the beam has an x-direction intensity distribution 408x and a y-direction intensity distribution 408y centered in respective directions at the variable placement beam centroid 404. The intensity distributions 408x, 408y can be or approximate Gaussian distributions or sinc distributions, for example.

An intensity threshold 410 is defined corresponding to a desired result (e.g., a desired intensity dosage received by a photosensitive material, a desired intensity at a surface for viewing, etc.). In many instances, the desired result is a function of accumulated dosage (e.g., which can be a function of time, or a function of the number of shots or overlapping image flashes), such as by integrating a continuous exposure (or multiplicity of shots). As an example, a photosensitive material in lithography or 3D printing can react (e.g., cross-link) as a result of receiving a dosage above the intensity threshold 410, which dosage may be integrated as a function of time for a continuous exposure by a beam or multiple discrete exposures by the beam at the variable placement beam centroid 404 and other nearby positions within a close proximity as to allow an overlapping dose (generally half the beam's pixel size (e.g., full-width-half-max intensity level)). Similarly, a perceived intensity by a human eye in a theater application can integrate the intensity at the variable placement beam centroid 404. An above-threshold area 412 is shown on, e.g., the substrate 107 where the beam has a dosage or intensity above the intensity threshold 410 to illustrate the extent of the exposure by the beam. Different beams having different intensity distributions and/or different thresholds can achieve different above-threshold areas.

The table below provides prescriptions for various components of the relay 104 of FIG. 1 as an example. Other prescriptions can be implemented by other examples. The table indicates surfaces with reference to surfaces of FIG. 1, radii of those surfaces (the directionality of which is apparent from FIG. 1), distances between surfaces along respective paths of beams 150, 152, 154, 156, a type of glass or surface implemented as the indicated surface or between the indicated surface and the subsequent surface (which is apparent from FIG. 1), and a clear diameter or image field diameter of the surfaces. It is noted that the absence of a material or type for an indicated surface can indicate an air gap between the indicated surface and the subsequent surface.

| | | FIG. 1 | |
|---|---|---|---|
| Surface | Description | reference number | Technical Information |
| OBJ | The surface | 102 | Image field Diameter: 41.094 mm |
| | of the | | Distance to next surface: 0.0483 mm of air-space |
| | pixelated | | Radius of Curvature: FLAT |
| | light source | | |
| 1 | Leading | 172 | Image field Diameter: 41.09916 mm |
| | surface of | | Distance to next surface: 2.997 mm of S-FSL5 |
| | cover-glass | | Radius of Curvature: FLAT |
| 2 | Trailing | 174 | Image field diameter: 41.09436 mm |
| | surface of | | Distance to next surface: 29.98246 mm of air-space |
| | cover-glass | | Radius of Curvature: FLAT |
| 3 | Leading | 176 | Image field diameter: 43.65437 mm |
| | surface of | | Distance to next surface: 3.5 mm of SUPRASIL |
| | lens 109 | | Radius of Curvature: −33.57748 mm |
| 4 | Trailing | 178 | Image field diameter: 45.6701 mm |
| | surface of | | Distance to next surface: 81.46747 mm of air-space |
| | lens 109 | | Radius of Curvature: −36.36295 mm |
| 6 | Concave | 180 | Image field diameter: 58.13344 mm |
| | reflective | | Distance to next surface: 60.22604 mm of air-space |
| | surface 110 | | Radius of Curvature: −116.5531 mm |
| 7 | Convex | 112 | Image field diameter: 5.972435 mm |
| | reflective | | Distance to next surface: 60.22604 mm of air-space |
| | surface 112 | | Radius of Curvature: −55.86982 mm |
| 8 | Concave | 182 | Image field diameter: 57.80507 mm |
| | reflective | | Distance to next surface: 81.46747 mm of air-space |
| | surface 110 | | Radius of Curvature: −116.5531 mm |
| 10 | Leading | 184 | Image field diameter: 45.53732 mm |
| | surface of | | Distance to next surface: 3.5 mm of SUPRASIL |
| | lens 109 | | Radius of Curvature: −36.36295 mm |
| 11 | Trailing | 186 | Image field diameter: 43.5546 mm |
| | surface of | | Distance to next surface: 31.44364 mm of air-space |
| | lens 109 | | Radius of Curvature: −33.57748 mm |
| 13 | Image | | Image field diameter: 41.09389 mm |
| | plane of | | |
| | relay | | |

Various modifications can be made to the projection system 100 of FIG. 1 while remaining within the scope of other examples. Different and/or additional optics can be implemented with or without the relay 104. For example, the beams 150 can be projected directly from the pixelated light source 102 to the convex reflective surface 112, which can reflect the beams 154 directly to the projection lens 106 and/or substrate 107. In other examples, any number and/or types of reflective surfaces or lenses can intervene. As an example, in a theater application, three relays each with a corresponding light source can be implemented, where one of the light sources projects red light, another green light, and another blue light. These light sources can be duty-cycle alternating between red, green, and blue. The relays can include dichroic beam splitting cubes to merge the three images of the relays into a same projection lens. Further, in other examples, the convex reflective surface 112 can be moved in other ways. For example, instead of being rotated, the convex reflective surface 112 can be translated in a circular movement, which may be generally parallel to a tangential surface at a center point of the concave reflective surface 110. Other modifications can be made.

General Operation

Rotation of the convex reflective surface 112 can permit variably locating where beams can be incident in the image of the relay, which can permit redundancy, more precise edge definition in an image, binary or greyscale imaging, and/or imaging with different wavelengths of light. Various examples are provided to illustrate these aspects.

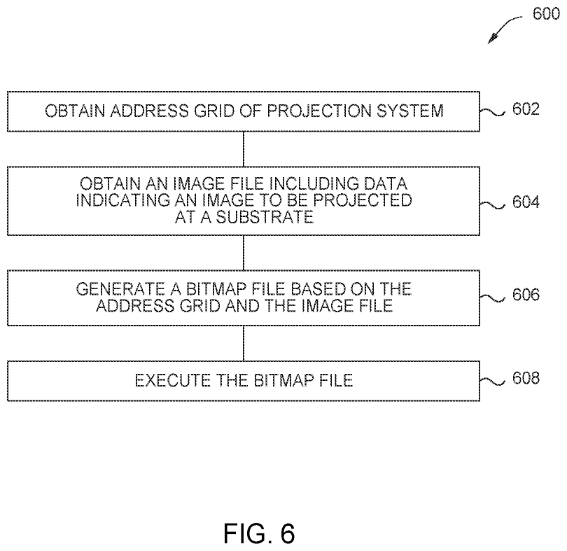

FIG. 6 is a flowchart of a method 600 for generating an image in an image of a relay (e.g., an intermediate focal plane) according to some examples. At block 602, an address grid of the projection system is obtained. The address grid contains a set of address points. Each address point corresponds to a location in the image of the relay where one or more beams may be incident in the image of the relay (e.g., the projection lens 106) when a beam centroid of a respective beam aligns with that location in the image of the relay. Although the description herein may refer to an address point or address grid in the image of the relay, any address point and address grid may be a mathematical transform corresponding to such locations in the image of the relay given the configuration of optics (e.g., the Offner relay) implemented, including the configuration of the pixelated light source 102 and the convex reflective surface 112.

At block 604, an image file including data indicating the image to be projected at the substrate is obtained. Generally, an image to be projected at the substrate can be modeled (e.g., in computer-aided design (CAD) software) in a two dimensional (2D) or three dimensional (3D) space or can be captured (e.g., as a picture or part of a video). Modelling or capturing an image can generate an image file (e.g., .GDS design file, a .STL file, a .MOV file, a .JPG file, a .MP4 file, etc.). More specifically, the image file can be a .GDS file for a lithography application, a .STL file for a layer slice for a 3D printer application, or any image or movie file for a theater application.

At block 606, a bitmap file is generated based on the address grid and the image file. Generating a bitmap is described below. A bitmap file can have one or more bitmaps that populate the address grid. Each bitmap can correspond to a given intensity dose of light, a given wavelength of light, and/or a given rotational position of the convex reflective surface 112. A person having ordinary skill in the art will readily understand how multiple bitmaps can be generated to be imaged in a sequence to implement, e.g., greyscale imaging by image convolution, imaging with multiple wavelengths of light, or a combination thereof.

The image file can be decomposed into one or more polygons, where each respective polygon has, if appropriate, a dosage and/or wavelength of light to be imaged. The polygonal(s) are then overlaid onto the address grid. The address points of the address grid overlaid by a polygon are transformed into a bitmap based on a rotational position of the convex reflective surface 112 and, if appropriate, having the given dosage and/or wavelength. Generally, the bitmap indicates which spatial light modulator pixels to turn on given the rotational position of the convex reflective surface 112 and, if appropriate, the given dosage and/or wavelength. The bitmap file can include a sequence of bitmaps, where the bitmaps can have a same or different rotational position, dosage of light, and/or wavelength of light. The sequence of bit maps can be used to implement binary imaging, greyscale imaging (e.g., using image convolution), and/or imaging with different wavelengths of light.

The operations of blocks 602-606 can be performed by a processor executing instruction code of a generation application, as described above. The processor can be the processor 160 of the controller 108, as stated previously, or another processor. The instruction code of the generation application can be stored on the memory 162 and/or storage 164 (e.g., when the generation application is executed on the controller 108), or on different memory or storage (e.g., when the generation application is executed by a different processor).

At block 608, the bitmap file is executed by the projection system. For example, the controller 108 can execute the bitmap file, e.g., by execution of the projection control application as described above. Execution of the bitmap file by the controller 108 causes the controller to control the pixelated light source 102 (e.g., selectively controlling spatial light modulator pixels to turn on and off) and to control the actuator 122 and thereby the rotation of the convex reflective surface 112. The controller 108 causes the actuator 122 to rotate the axle 114, which rotates the convex reflective surface 112. The encoder 126 reads positional information from the convex reflective surface 112 and feeds back that positional information to the controller 108. The controller 108 turns on spatial light modulator pixels to project respective beams based on a bitmap of the bitmap file and the corresponding rotational position of the convex reflective surface 112.

The bitmap file can be generated at block 606 a priori before being provided to the projection system for execution at block 608, or can be generated at block 606 at runtime by the projection system substantially contemporaneously with execution at block 608. The operation of block 608 can be performed by a processor executing instruction code of a projection control application, as described above. The processor can be the processor 160 of the controller 108, as stated previously. The instruction code of the generation application can be stored on the memory 162 and/or storage 164 (e.g., when the generation application is executed on the controller 108.

Orthogonal Address Grid

The following examples show orthogonal address grids that can be obtained and implemented by a projection system. Various address grids and arrays of path centers of paths can be conceptualized in the context of being in the image of the relay (e.g., the intermediate focal plane). This may provide a reference point of comparison between an address grid and an array of path centers of paths for simplicity and clarity in some circumstances. An address grid and corresponding features can be implemented using a transform irrespective of the substrate on which the image of the relay is subsequently projected, in some examples.

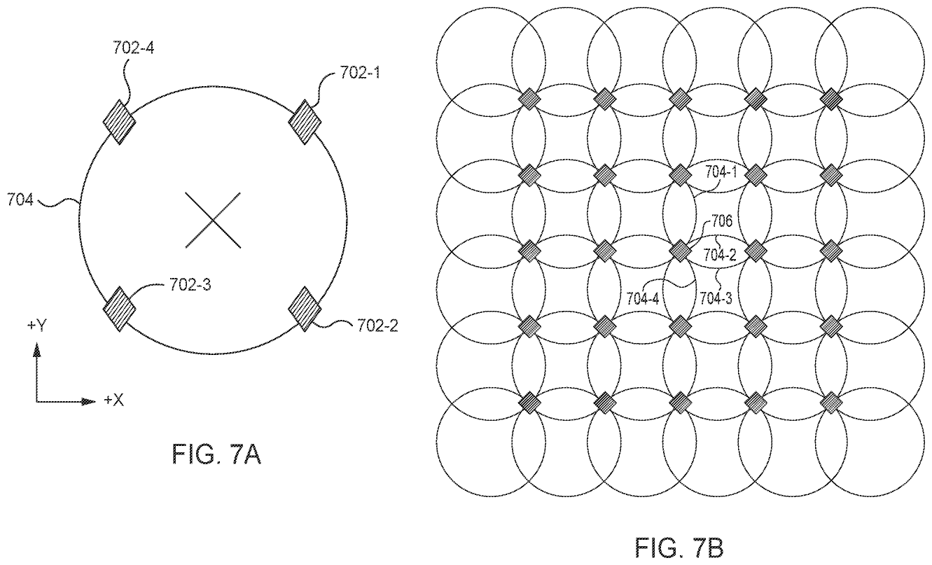

FIG. 7A shows four exposure locations 702-1, 702-2, 702-3, 702-4 (collectively or individually, exposure location(s) 702) along a path 704. The exposure locations 702 are positioned separated by 90 degrees along the path 704 from each neighboring exposure location 702. Each exposure location 702 is 45 degrees off of x and y axes extending through a path center of the path 704. The exposure locations 702 indicate locations where a beam may be turned on for some limited duration (e.g., where a shot can occur).

FIG. 7B shows a resulting address grid when the exposure locations 702 along respective paths 704 are replicated for each spatial light modulator pixel of the pixelated light source 102. Although not explicitly illustrated, an array of path centers of paths corresponds to the paths 704, and has a one-to-one correspondence with the array of spatial light modulator pixels of the pixelated light source 102. A person having ordinary skill in the art will readily envision the array of path centers of paths based on the illustrated paths in FIG. 7B and in other similar figures.

The exposure locations 702 of the paths 704 form address points of the address grid in FIG. 7B. An example address point 706 is identified in FIG. 7B. The address grid of FIG. 7B is an orthogonal address grid. The orthogonal address grid of FIG. 7B forms when the ratio of the radius to the pitch (r/P) is approximately 0.714. This ratio and the exposure locations 702 can result in the address grid having address points with a same linear and areal density as the array of path centers of paths 704.

Each of the address points of the address grid of FIG. 7B can be exposed by any of four beams. For example, address point 706 corresponds to exposure locations 702-2, 702-4, 702-3, 702-1 of paths 704-1, 704-2, 704-3, 704-4, respectively. Hence, the address point 706 can be exposed by any of the four beams that traverse along respective paths 704-1, 704-2, 704-3, 704-4, which can permit four times redundancy.

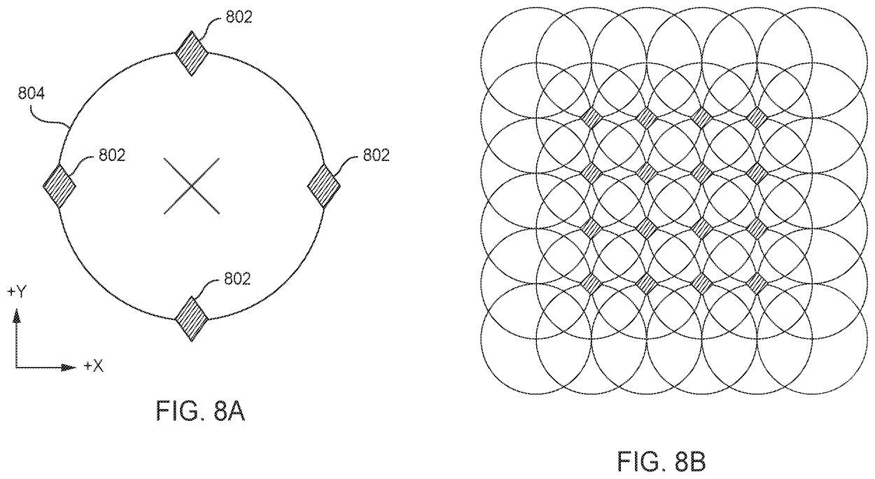

FIG. 8A shows four exposure locations 802 along a path 804. The exposure locations 802 are positioned separated by 90 degrees along the path 804 from each neighboring exposure location 802. Each exposure location 802 is on an x or y axis extending through a path center of the path 804. The exposure locations 802 indicate locations where a beam may be turned on for some limited duration (e.g., where a shot can occur).

FIG. 8B shows a resulting address grid when the exposure locations 802 along respective paths 804 are replicated for each spatial light modulator pixel of the pixelated light source 102. The exposure locations 802 of the paths 804 form address points of the address grid in FIG. 8B. The address grid of FIG. 8B is an orthogonal grid. As shown by FIG. 8B, since the paths 804 that have neighboring path centers aligned along a row (and a column, respectively) of the array meet (e.g., at respective address points) without intersecting, a radius of the path 804 is equal to the pitch between neighboring path centers aligned along a row (and a column, respectively) of the array (e.g., r=P). Accordingly, the ratio of the radius to the pitch (r/P) is approximately 1. This ratio and the exposure locations 802 can result in the address grid having address points with a same linear and areal density as the array of path centers of paths 804. Each of the address points can be exposed by any of four beams, similar to FIG. 7B, which can permit four times redundancy.

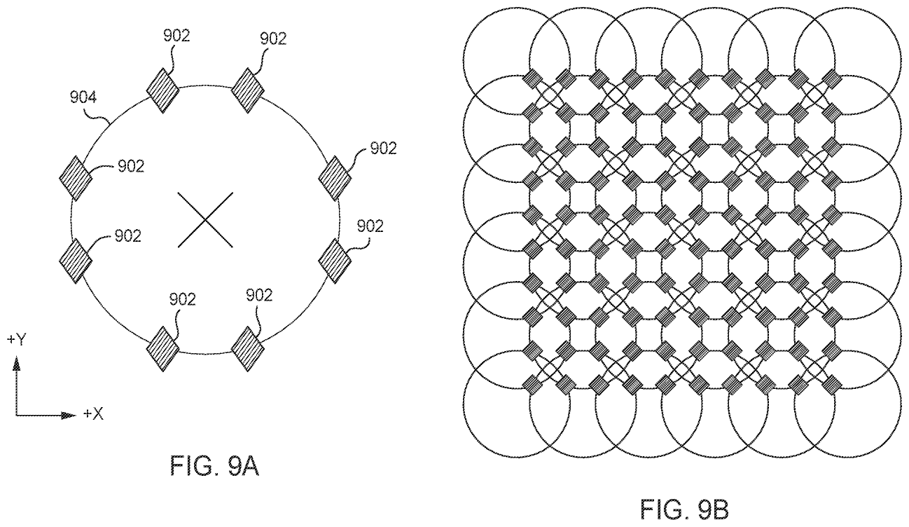

FIG. 9A shows eight exposure locations 902 along a path 904. Pairs of the exposure locations 902 are positioned along the path 904, disposed separated by an x or y axis extending through the path center of the path 904, and separated by plus or minus approximately 18.4 degrees from the respective x or y axis. The exposure locations 902 indicate locations where a beam may be turned on for some limited duration (e.g., where a shot can occur).

FIG. 9B shows a resulting address grid when the exposure locations 902 along respective paths 904 are replicated for each spatial light modulator pixel of the pixelated light source 102. The exposure locations 902 of the paths 904 form address points of the address grid in FIG. 9B. The address grid of FIG. 9B is an orthogonal grid. As shown by FIG. 9B, the paths 904 that have neighboring path centers aligned along a diagonal of the array intersect at respective exposure locations 902. The ratio of the radius to the pitch (r/P) is approximately 0.791

$$( e . g . , r / P = \sqrt{\frac{5}{8}} ) .$$

This ratio and the exposure locations 902 can result in the address grid having address points with a linear density that is two times greater than the linear density of the array of path centers of paths 904, and with an areal density that is four times greater than the areal density of the array of path centers. The pitch between the address points can be half of the pitch (e.g., a sub-pixel pitch) between neighboring path centers. Each of the address points can be exposed by any of two beams, which can permit two times redundancy.

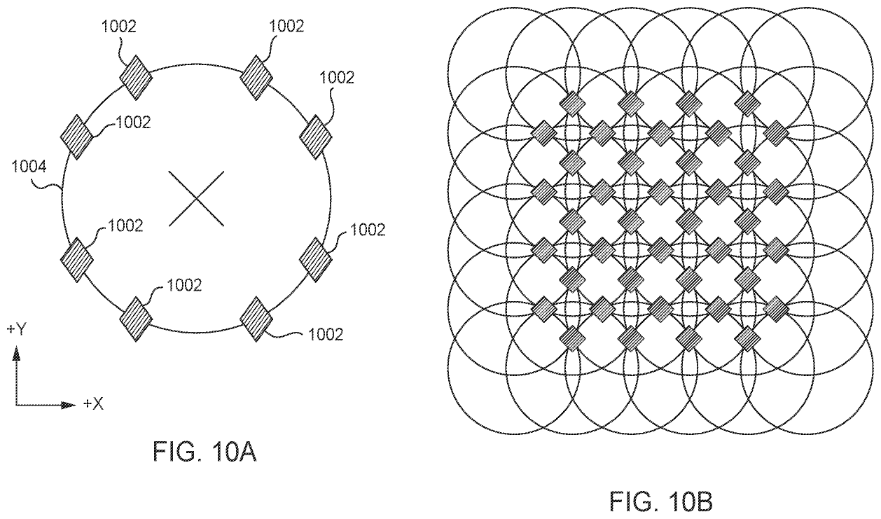

FIG. 10A shows eight exposure locations 1002 along a path 1004. Pairs of the exposure locations 1002 are positioned along the path 1004, disposed separated by a diagonal bisecting the x and y axes extending from the path center of the path 1004, and separated by plus or minus approximately 18.4 degrees from the respective diagonal. The exposure locations 1002 indicate locations where a beam may be turned on for some limited duration (e.g., where a shot can occur).

FIG. 10B shows a resulting address grid when the exposure locations 1002 along respective paths 1004 are replicated for each spatial light modulator pixel of the pixelated light source 102. The exposure locations 1002 of the paths 1004 form address points of the address grid in FIG. 10B. The address grid of FIG. 10B is an orthogonal grid, and is rotated relative to the underlying array of path centers of the paths 904. As shown by FIG. 10B, the paths 1004 that have neighboring path centers aligned along a diagonal of the array intersect at respective exposure locations 1002. The address grid is rotated 45 degrees relative to the array of the path centers of the paths 904. The ratio of the radius to the pitch (r/P) is approximately 1.118

$$( e . g . , r / P = \frac{\sqrt{5}}{2} ) .$$

This ratio and the exposure locations can result in the address grid having address points with a linear density that is approximately 1.414 (e.g., \sqrt{2}) times greater than the linear density of the array of path centers of the paths 1004, and with an areal density that is two times greater than the areal density of the array of path centers. The pitch between the address points can be approximately 0.707

$$( e . g . , \frac{\sqrt{2}}{2} )$$

times the pitch between path centers of paths 1004. Each of the address points can be exposed by any of four beams, which can permit four times redundancy.

Binary Projection

In some examples, the projection system can implement binary projection. In binary projection, each beam projected by the pixelated light source 102 has a same light intensity and is projected for a same duration. Each beam has a same dose per exposure. Binary projection can be implemented to achieve a binary image or a greyscale image.

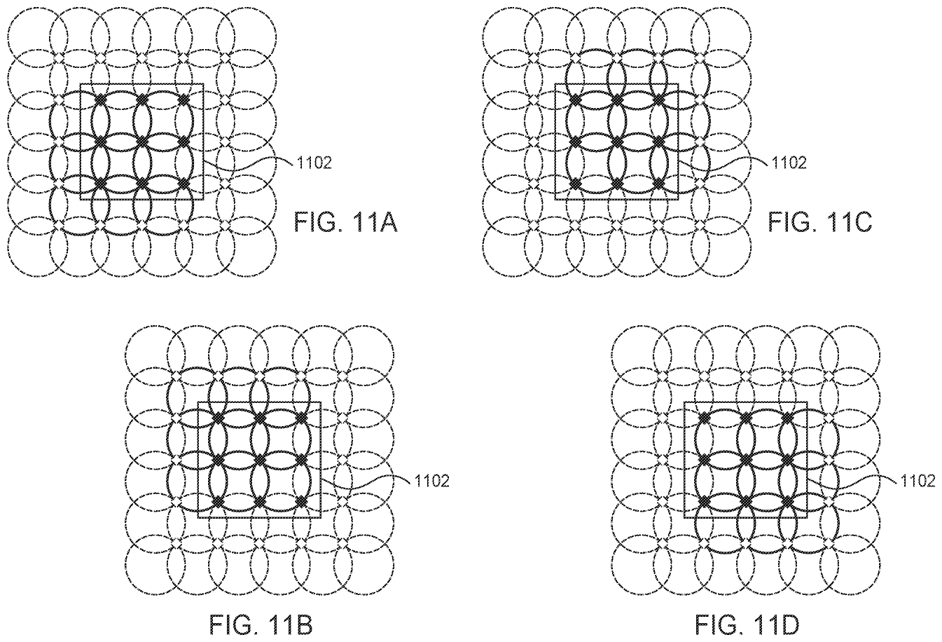

A binary image can be achieved using binary projection where each address point receives a same dosage or no dosage. A received dosage can be accumulated. The circumstances under which an address point is exposed can vary. Referring back to FIGS. 7A and 7B for convenience, each address point corresponds to an exposure location 702 of four paths 704. Hence, each address point may be exposed up to and including four times during one revolution of the convex reflective surface 112. A binary image can be achieved using four bitmaps in this example. FIGS. 11A, 11B, 110, and 11D illustrate aspects of generating bitmaps according to some examples, and in the context of the address grid of FIG. 7B. FIGS. 11A-11D each show a polygon 1102 that is to be imaged as a binary image. Generally, each of FIGS. 11A-11D identifies which spatial light modulator pixels (as indicated by the corresponding path) the respective bitmap turns on to generate the image of the polygon 1102. The address points within the polygon 1102 are to be exposed to project the image. The intensity dose and wavelength for each beam that is turned on resulting from the bitmaps are respectively the same.

FIG. 11A illustrates which spatial light modulator pixels are to be turned on and turned off when a rotational position (a “first position,” for convenience) of the convex reflective surface 112 aligns variable placement beam centroids with exposure locations 702-1. The spatial light modulator pixels that have variable placement beam centroids that align with respective address points within the polygon 1102 (and indicated by solid paths) are indicated as turned on in a first bitmap, while other spatial light modulator pixels (indicated by dashed paths) are indicated as turned off in the first bitmap.

Similarly, FIGS. 11B, 11C, 11D illustrate which spatial light modulator pixels are to be turned on and turned off when rotational positions (a “second position,” “third position,” and “fourth position,” for convenience) of the convex reflective surface 112 aligns variable placement beam centroids with exposure locations 702-2, 702-3, 702-4, respectively. The spatial light modulator pixels that have variable placement beam centroids that align with respective address points within the polygon 1102 (and indicated by solid paths) are indicated as turned on in a second, third, and fourth bitmap, respectively, while other spatial light modulator pixels (indicated by dashed paths) are indicated as turned off in the second, third, and fourth bitmap, respectively.

The first bitmap is to be executed when the convex reflective surface 112 is in the first position. The second bitmap is to be executed when the convex reflective surface 112 is in the second position. The third bitmap is to be executed when the convex reflective surface 112 is in the third position. The fourth bitmap is to be executed when the convex reflective surface 112 is in the fourth position.

Executing the bitmap file that includes the first, second, third, and fourth bitmaps includes turning on spatial light modulator pixels as indicated by the first, second, third, and fourth bitmaps when the convex reflective surface 112 is in the first, second, third, and fourth position, respectively. The spatial light modulator pixels indicated by having solid line paths in FIG. 11A are turned on when the convex reflective surface 112 is in the first position, as indicated by the first bitmap. The spatial light modulator pixels indicated by having solid line paths in FIG. 11B are turned on when the convex reflective surface 112 is in the second position, as indicated by the second bitmap. The spatial light modulator pixels indicated by having solid line paths in FIG. 110 are turned on when the convex reflective surface 112 is in the third position, as indicated by the third bitmap. The spatial light modulator pixels indicated by having solid line paths in FIG. 11D are turned on when the convex reflective surface 112 is in the fourth position, as indicated by the fourth bitmap.

The dose projected by each spatial light modulator pixel when turned on is a same dose dᵢ in this example. Hence, after one revolution of the convex reflective surface 112, each address point within the polygon 1102 receives an accumulated dosage of 4dᵢ since each such address point is exposed to the dose dᵢ four times within one revolution. The address points within a polygon can receive a greater accumulated dosage by executing the bitmap file for multiple revolutions of the convex reflective surface 112.

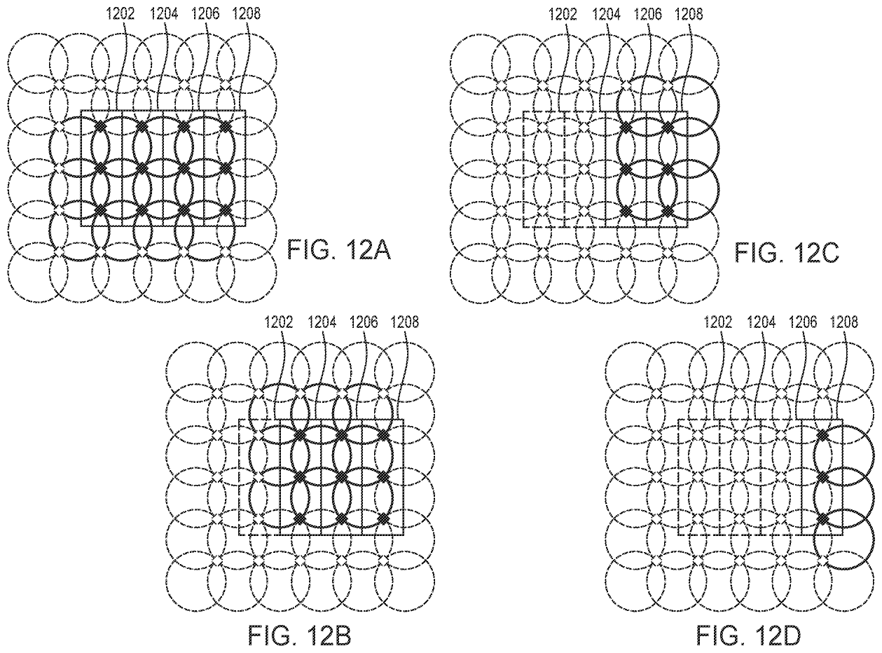

A greyscale image can be achieved using binary projection where each address point can receive a dosage along a predetermined scale. A received dosage can be accumulated. The circumstances under which an address point is exposed can vary. Referring back to FIGS. 7A and 7B for convenience, each address point corresponds to an exposure location 702 of four paths 704. Hence, each address point may be exposed up to and including four times during one revolution of the convex reflective surface 112. A greyscale image can be achieved using four bitmaps in this example. FIGS. 12A, 12B, 12C, and 12D illustrate aspects of generating bitmaps according to some examples, and in the context of the address grid of FIG. 7B. FIGS. 12A-12D each show polygons 1202, 1204, 1206, 1208. Polygon 1202 is to receive a 1× accumulated dosage. Polygon 1204 is to receive a 2× accumulated dosage. Polygon 1206 is to receive a 3× accumulated dosage. Polygon 1208 is to receive a 4× accumulated dosage. Generally, each of FIGS. 12A-12D identifies which spatial light modulator pixels (as indicated by the corresponding path) the respective bitmap turns on to generate the image of the polygons 1202-1208. The intensity dose and wavelength for each beam that is turned on resulting from the bitmaps are the same.

A person having ordinary skill in the art will readily understand the indicated bitmaps and execution in FIGS. 12A-12D based on the foregoing description of FIGS. 11A-11D; hence, detailed description of such is omitted. The dose projected by each spatial light modulator pixel when turned on is a same dose dᵢ in this example. Hence, after one revolution of the convex reflective surface 112, each address point within the polygon 1202 receives an accumulated dosage of dᵢ, each address point within the polygon 1204 receives an accumulated dosage of 2dᵢ; each address point within the polygon 1206 receives an accumulated dosage of 3dᵢ; and each address point within the polygon 1208 receives an accumulated dosage of 4dᵢ. The address points within a polygon can receive a greater (proportional) accumulated dosage by executing the bitmap file for multiple revolutions of the convex reflective surface 112.

Redundancy

In some examples, the projection system can have redundancy. Each address point in an address grid can be exposed by multiple spatial light modulator pixels. This can permit an address point to be exposed if a spatial light modulator pixel is defective.

Referring back to FIGS. 7A and 7B for convenience, each address point can be exposed multiple times per revolution of the convex reflective surface 112. As an example, the controller 108 can generally be configured to cause each address point within a polygon to be exposed by fewer than all of the exposure locations 702 corresponding to that address point during a single revolution of the convex reflective surface 112. If any spatial light modulator pixel is defective, one or more exposure locations 702 can be implemented along one or more other paths 704 to expose the address points corresponding to exposure locations 702 of the defective spatial light modulator pixel. As an example, the controller 108 can generally be configured to cause each address point within a polygon to be exposed as an exposure location 702-1 of a path 704 at the respective address point. If, however, a spatial light modulator pixel having a path 704 with an exposure location 702-1 is defective or inoperable, the controller 108 can be configured to cause a different spatial light modulator pixel to expose the address point corresponding to the exposure location 702-1 of the defective spatial light modulator pixel. As an example with reference to FIG. 7B, if the spatial light modulator pixel having path 704-4 is defective or inoperable, the address point 706 can be exposed as exposure location 702-2 of path 704-1, as exposure location 702-3 of path 704-3, and/or as exposure location 702-4 of path 704-2. This concept can be extrapolated to a number of different implementations.

Referring to previous address grids, the address grid of FIG. 7B can achieve four times redundancy since each address point may be exposed as an exposure location of four different paths of respective four spatial light modulator pixels. The address grid of FIG. 8B can likewise achieve four times redundancy. The address grid of FIG. 9B can achieve two times redundancy since each address point may be exposed as an exposure location of two different paths of respective two spatial light modulator pixels. The address grid of FIG. 10B can achieve four times redundancy.

Greyscale Projection

In some examples, the projection system can implement greyscale projection. In greyscale projection, a beam projected by the pixelated light source 102 can have any of a number of doses, which can result from different light intensities, different exposure durations, or a combination thereof. Greyscale projection can be implemented to achieve a greyscale image. In some examples, greyscale projection can be implemented to achieve a binary image.

A greyscale image can be achieved using greyscale projection where each address point may receive any of a number of different dosages. A received dosage can be accumulated. The circumstances under which an address point is exposed can vary. Referring back to FIGS. 7A and 7B for convenience, each address point corresponds to an exposure location 702 of four paths 704. Hence, each address point may be exposed up to and including four times during one revolution of the convex reflective surface 112. Each exposure location 702 along a path can be assigned a respective bitwise exposure dose (e.g., (2^{(N-1)})dᵢ, where N is the corresponding position of the exposure location 702). In FIG. 7B, a greyscale image having 16 greyscale increments of accumulated dosage (e.g., 0, dᵢ, 2dᵢ, . . . 15dᵢ) can be achieved with one rotation of the convex reflective surface 112. A simplified example will be described according to this technique, and a person having ordinary skill in the art will readily understand how to extrapolate from this description other examples having different greyscale increments.

To illustrate this further with reference to FIGS. 7A and 7B and from the perspective of a given address point, assume that:
A) when a beam centroid aligns with exposure location 702-1, the corresponding beam can expose the exposure location 702-1 with an exposure dose of dᵢ, which is referred to as an “A” shot for convenience;
B) when a beam centroid aligns with exposure location 702-2, the corresponding beam can expose the exposure location 702-2 with an exposure dose of 2dᵢ, which is referred to as a “B” shot for convenience;
C) when a beam centroid aligns with exposure location 702-3, the corresponding beam can expose the exposure location 702-3 with an exposure dose of 4dᵢ, which is referred to as an “C” shot for convenience; and
D) when a beam centroid aligns with exposure location 702-4, the corresponding beam can expose the exposure location 702-4 with an exposure dose of 8dᵢ, which is referred to as an “D” shot for convenience.
   The address point 706 can receive any accumulated dosage (e.g., 0, dᵢ, 2dᵢ, . . . 15dᵢ) with different combinations of the A, B, C, and D shots from beams having different paths 704-1, 704-2, 704-3, 704-4. The address point 706 can receive an A shot (e.g., an exposure dose of dᵢ) from the beam that has path 704-4; can receive a B shot (e.g., an exposure dose of 2dᵢ) from the beam that has path 704-1; can receive a C shot (e.g., an exposure dose of 4dᵢ) from the beam that has path 704-3; and can receive a D shot (e.g., an exposure dose of 8dᵢ) from the beam that has path 704-2. Various increments of accumulated dosage in a greyscale image and corresponding combination of shots are listed below that can be achieved by one rotation of the convex reflective surface 112 in this example. A person having ordinary skill in the art will readily understand the applicability of this description for address point 706 to any address point in the address grid.

| Accumulated | |
|---|---|
| Dosage at | Shot |
| Address Point | Combination |
| 0 | No shot |
| dᵢ | A |
| 2dᵢ | B |
| 3dᵢ | B + A |
| 4dᵢ | C |
| 5dᵢ | C + A |
| 6dᵢ | C + B |
| 7dᵢ | C + B + A |
| 8dᵢ | D |
| 9dᵢ | D + A |
| 10dᵢ | D + B |
| 11dᵢ | D + B + A |
| 12dᵢ | D + C |
| 13dᵢ | D + C + A |
| 14dᵢ | D + C + B |
| 15dᵢ | D + C + B + A |

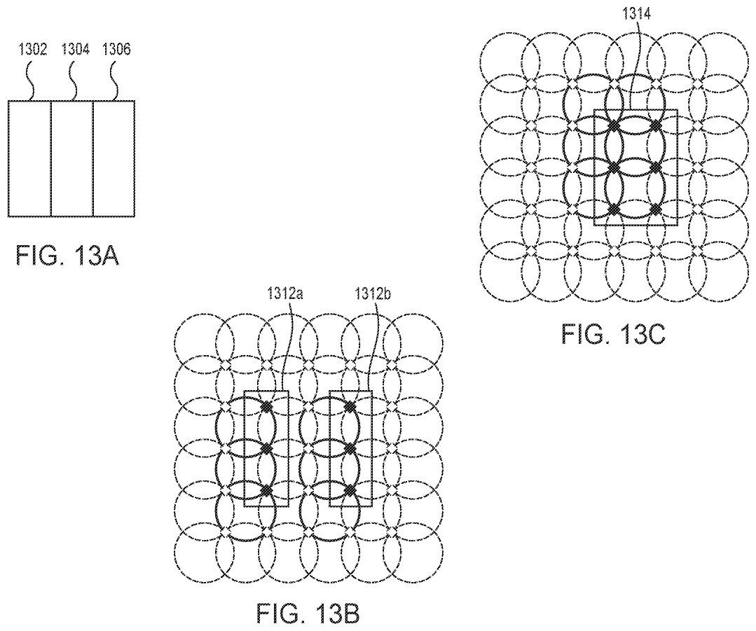

FIG. 13A illustrates a greyscale image having four greyscale increments of accumulated dosage (e.g., 0, dᵢ, 2dᵢ, 3dᵢ). FIG. 13A includes a 1× dosage polygon 1302, a 2× dosage polygon 1304, and a 3× dosage polygon 1306. As shown in FIGS. 13B and 13C, the dosage polygons 1302, 1304, 1306 are decomposed into first bitwise dose polygons 1312a, 1312b and a second bitwise dose polygon 1314. The first bitwise dose polygons 1312a, 1312b correspond to areas to be exposed by a first bitwise dose dᵢ (e.g., 2° dᵢ), and the second bitwise dose polygon 1314 corresponds to an area to be exposed by a second bitwise dose 2dᵢ (e.g., 2¹dᵢ). The first bitwise dose polygon 1312a corresponds to the 1× dosage polygon 1302, and the first bitwise dose polygon 1312b corresponds to the 3× dosage polygon 1306. The second bitwise dose polygon 1314 has portions corresponding to the 2× dosage polygon 1304 and the 3× dosage polygon 1306.

FIGS. 13B and 13C illustrate aspects of generating bitmaps according to some examples. Each of FIGS. 13B and 13C identifies which spatial light modulator pixels (as indicated by the corresponding path) the respective bitmap turns on to generate the image of the polygons 1302-1306 of FIG. 13A. The address points within the polygons 1312a, 1312b, 1314 are to be exposed to project the image. Each beam that is turned on resulting from the bitmap associated with FIG. 13C has a dose that is two times the dose of each beam that is turned on resulting from the bitmap associated with FIG. 13B.

FIG. 13B illustrates which spatial light modulator pixels are to be turned on and turned off when a rotational position (a “first position,” for convenience) of the convex reflective surface 112 aligns variable placement beam centroids with exposure locations 702-1. The spatial light modulator pixels that have variable placement beam centroids that align with respective address points within the polygons 1312a, 1312b (and indicated by solid paths) are indicated as turned on in a first bitmap, while other spatial light modulator pixels (indicated by dashed paths) are indicated as turned off in the first bitmap.

FIG. 13C illustrates which spatial light modulator pixels are to be turned on and turned off when a rotational position (a “second position,” for convenience) of the convex reflective surface 112 aligns variable placement beam centroids with exposure locations 702-2. The spatial light modulator pixels that have variable placement beam centroids that align with respective address points within the second bitwise dose polygon 1314 (and indicated by solid paths) are indicated as turned on in a second bitmap, while other spatial light modulator pixels (indicated by dashed paths) are indicated as turned off in the second bitmap.

Executing the bitmap file that includes the first and second bitmaps includes turning on spatial light modulator pixels as indicated by the first and second bitmaps when the convex reflective surface 112 is in the first and second position, respectively, like described previously. The dose projected by each spatial light modulator pixel when turned on when the first bitmap is executed (when the convex reflective surface 112 is in the first position) is a first bitwise dose dᵢ (e.g., 2⁰dᵢ), and the dose projected by each spatial light modulator pixel when turned on when the second bitmap is executed (when the convex reflective surface 112 is in the second position) is a second bitwise dose 2dᵢ (e.g., 2¹dᵢ). Hence, after one revolution of the convex reflective surface 112, each address point within the dosage polygons 1302, 1304, 1306 can receive any increment of an accumulated dosage of 0, dᵢ, 2dᵢ, 3dᵢ. For example, address points within both the polygons 1312b, 1314 (which corresponds to 3× dosage polygon 1306) receive an accumulated dosage of 3dᵢ as a result of two exposures, the first exposure having a dose of dᵢ (FIG. 13B) and the second exposure having a dose of 2dᵢ (FIG. 13C). Address points within the second bitwise dose polygon 1314 but outside the first bitwise dose polygons 1312a, 1312b (which corresponds to 2× dosage polygon 1304) receive an accumulated dosage of 2dᵢ as a result of one exposure having a dose of 2dᵢ (FIG. 13C). Address points within the first bitwise dose polygon 1312a (which corresponds to 1× dosage polygon 1302) receive an accumulated dosage of dᵢ as a result of one exposure having a dose of dᵢ (FIG. 13B). A person having ordinary skill in the art can understand the other exposure locations along the paths (e.g., exposure locations 702-3, 702-4 of FIG. 7A) can deliver dosages of 4dᵢ and 8dᵢ, thereby enabling polygons to accumulate any integer greyscale dosages from 0 to 15dᵢ. Additionally, the address points within a polygon can receive a greater accumulated (proportional) dosage by executing the bitmap file for multiple revolutions of the convex reflective surface 112. Even further, one revolution, as described above, implements 4-bit greyscale imaging, and two revolutions (or more) can implement 8-bit (or more) greyscale imaging.

Sub-Pixel Edge Control

Depending on the application (e.g., 3D printing, lithography, video projection, etc.), sub-pixel edge control of an image can be achieved by differing mechanisms. In some examples, sub-pixel edge control can be achieved using greyscale imaging. In some examples, sub-pixel edge control can be achieved using a sub-pixel resolution address grid.

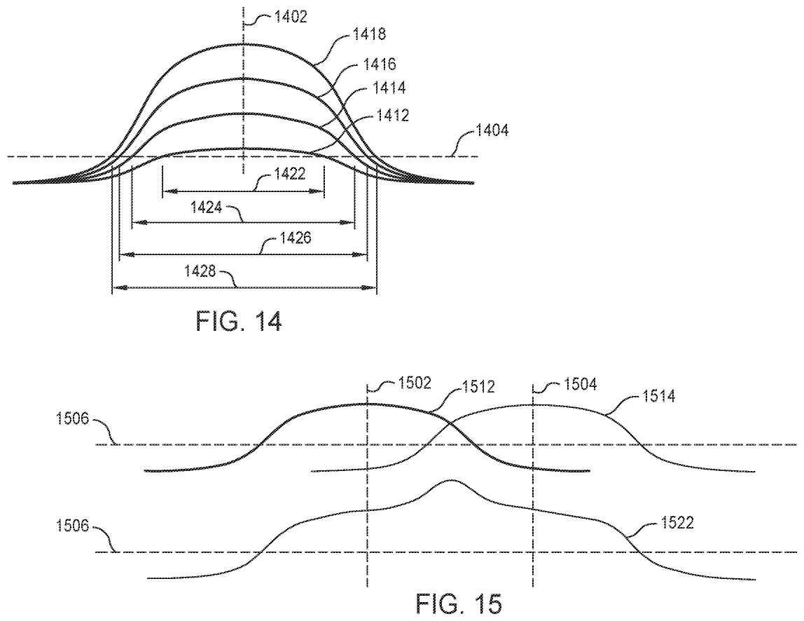

FIG. 14 illustrates aspects of sub-pixel edge control using greyscale imaging. FIG. 14 shows an address point 1402, a line edge threshold 1404, intensity dosage distribution 1412, and accumulated intensity dosage distributions 1414, 1416, 1418. The line edge threshold 1404 is a threshold above which an accumulated intensity dosage must be to form an edge in an image (e.g., in a photosensitive material). Intensity dosage distribution 1412 is a distribution after a single exposure dose. Accumulated intensity dosage distribution 1414 is a distribution accumulated after two equal exposure doses (e.g., each equal to the intensity dosage distribution 1412). Accumulated intensity dosage distribution 1416 is a distribution accumulated after three equal exposure doses (e.g., each equal to the intensity dosage distribution 1412). Accumulated intensity dosage distribution 1418 is a distribution accumulated after four equal exposure doses (e.g., each equal to the intensity dosage distribution 1412). The exposure doses have been described and are illustrated in FIG. 14 to be equal; this is for simplicity to understand an accumulated intensity dosage distribution's effect on an edge. A person having ordinary skill in the art will readily understand how different greyscale techniques, such as described above having accumulated dosages of 0, dᵢ, . . . , 15 dᵢ, can be implemented to similar effect.

Above-threshold area 1422 (e.g., due to the 2D nature of the distribution as described with respect to FIG. 5) is the area in which the intensity dosage distribution 1412 is above the line edge threshold 1404 (and hence, indicates where a line edge can be formed). Above-threshold area 1424 is the area in which the accumulated intensity dosage distribution 1414 is above the line edge threshold 1404 (and hence, indicates where a line edge can be formed). Above-threshold area 1426 is the area in which the accumulated intensity dosage distribution 1416 is above the line edge threshold 1404 (and hence, indicates where a line edge can be formed). Above-threshold area 1428 is the area in which the accumulated intensity dosage distribution 1418 is above the line edge threshold 1404 (and hence, indicates where a line edge can be formed).

As indicated in FIG. 14, a line edge placement can be controlled based on the accumulated intensity dosage. A larger accumulated intensity dosage pushes where a line edge can be formed further from the address point 1402. Above-threshold areas 1422, 1424, 1426, 1428 are progressively larger with increasing intensity dosage distributions 1412, 1414, 1416, 1418. The line edge placement can be at different placements between address points and can therefore achieve sub-pixel placement. A tradeoff to this edge line control can be the accumulated intensity dosage at the address point 1402 increases with placement of a line edge further from the address point 1402. In some applications, the increased intensity dosage at the address point 1402 can affect a depth to which a photosensitive material is exposed.

FIG. 15 illustrates aspects of sub-pixel edge control using a sub-pixel address grid. An example sub-pixel address grid is illustrated in and described with respect to FIG. 9B. FIG. 15 shows neighboring address points 1502, 1504 and a line edge threshold 1506. An exposure dose distribution 1512 for an exposure at address point 1502 is shown, and an exposure dose distribution 1514 for an exposure at address point 1504 is shown. The neighboring address points 1502, 1504 have a sub-pixel pitch, e.g., as described with respect to FIG. 9B. An accumulated intensity dosage 1522 is shown that accumulates the exposure dose distributions 1512, 1514. Since the address points 1502, 1504 have a sub-pixel pitch, the above-threshold area of the accumulated intensity dosage 1522 can cause a line edge placement to achieve sub-pixel placement. In some examples, binary imaging can be implemented, which permits peak accumulated intensity dosage to remain uniform (e.g., without corresponding increase) to place a line edge with sub-pixel resolution. Hence, in such examples, a line edge can be placed independently of depth to which a photosensitive material is exposed.

Different Wavelengths

In some examples, the projection system can implement projection with multiple wavelengths of light. In projection with multiple wavelengths, a beam projected by the pixelated light source 102 can have any of a number of wavelengths, which can further have different light intensities or dosages. Projection with multiple wavelengths can be implemented in applications such as in video projection (e.g., in movie theaters) and in applications where a photosensitive material on which an image is projected has different reactions to different wavelengths.

Projection with multiple wavelengths can be performed like described above with respect to greyscale projection, except with different wavelengths of light being projected instead of or in addition to the different doses of light. Referring back to FIGS. 7A and 7B for convenience, each address point corresponds to an exposure location 702 of four paths 704. Each exposure location 702 along a path can be assigned a respective wavelength of light (e.g., red light, green light, or blue light). In some examples, each exposure location 702 along a path is assigned a respective one of red light, green light, blue light, and yellow light. An image to be projected can be decomposed into polygons corresponding to the different wavelengths of light. Bitmaps can be generated for the polygons as described above with respect to FIGS. 13B and 13C, with each bitmap corresponding to a respective wavelength of light. In execution, after one revolution of the convex reflective surface 112, each address point within a polygon can receive any accumulated dosage of the different wavelengths of light.

Some examples can achieve imaging using different wavelengths with each wavelength being capable of being imaged along a greyscale. For example, video generally requires each of red, green, and blue light to have 6-bit to 8-bit levels of greyscale (e.g., 64 to 256 increments of greyscale). To achieve 8-bit levels of greyscale for a single wavelength of light using the example of FIGS. 7A and 7B, two revolutions of the convex reflective surface 112 (e.g., per video frame) are used. As described above with respect to greyscale projection, a first revolution implements dosages dᵢ, 2dᵢ, 4dᵢ, and 8dᵢ, and a second revolution implements dosages 16dᵢ, 32dᵢ, 64dᵢ, and 128dᵢ. Two revolutions would be implemented for each of the red, green, and blue light. Hence, to achieve 8-bit levels of greyscale imaging for each of the red, green, and blue light, six revolutions of the convex reflective surface 112 are used (e.g., per video frame). The revolution frequency of the convex reflective surface 112 can therefore be some positive integer multiple of six times the frame rate of the video. Intensities or doses can be scaled proportional to the integer multiple. Although described with respect to red, green, and blue light, a person having ordinary skill in the art will readily understand an implementation with fewer or more numbers of wavelengths of light (e.g., two colors of light, four colors of light, etc.).

Irregular Address Grid

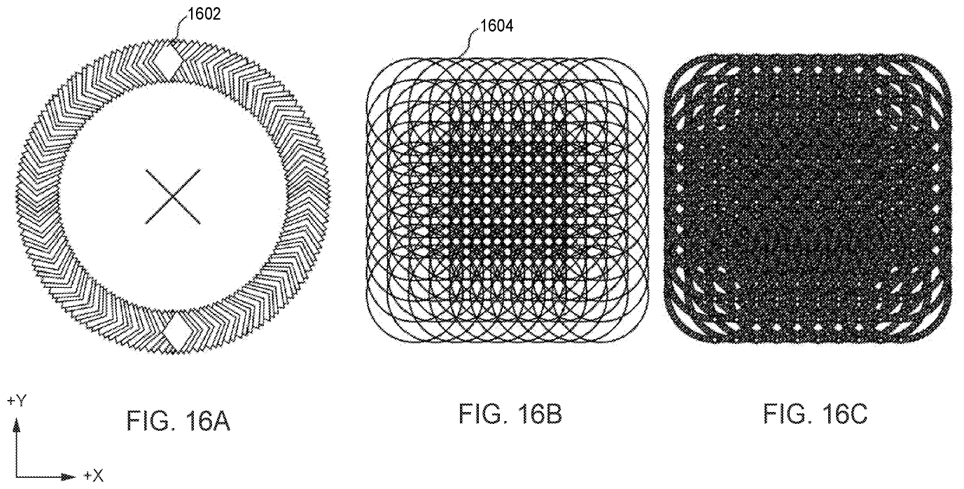

Some examples can implement an irregular address grid. An irregular address grid can be a non-orthogonal address grid that includes address points along overlapping circular paths of beams. FIG. 16A shows 150 exposure locations 1602 equally distributed along a path. The exposure locations 1602 indicate locations where a beam may be turned on for some limited duration (e.g., a shot can occur). FIG. 16B shows a pattern of overlapping paths 1604 where the ratio of the radius to the pitch (r/P) is approximately 2.35. FIG. 16C shows the exposure locations 1602 along the pattern of overlapping paths 1604. Each exposure location 1602 in FIG. 16C can form an independent address point. Some area in the address grid can have a spacing up to approximately 0.29 times the pitch between path centers of paths between exposure locations 1602 (e.g., which can be referred to as interstitial gaps). The exposure locations 1602 correspond to centroids of exposures and do not imply that other areas do not have a beam incident thereon, like described above with respect to FIG. 5.

An example similar to the example of FIGS. 16A through 16C was simulated and analyzed for uniformity of intensity of exposure within a polygon to be imaged. In the simulated example, 150 exposure locations along respective paths were implemented, and the ratio of the radius to the pitch (r/P) was 1.865. The intensity of the exposure within the polygon had a uniformity that had less than 2% rms (e.g., 1.78% rms) variation.

Even further, an analysis can be performed to identify possible exposure locations that can be skipped or omitted to further improve uniformity of intensity of exposure. Referring to the example of FIGS. 16A through 16C, various high intensity areas (e.g., hot spots) were identified based on simulating imaging a polygon. Some exposure locations along paths were identified as contributing to these high intensity areas and were determined to possibly be skipped or omitted. Assume that exposure locations 1602 are numbered beginning at location 1 where the positive direction y-axis (+Y) intersects the path 1604 and are incremented in a clockwise direction around the path 1604. For example, location 150 would be the exposure location 1602 immediately counter-clockwise from location 1, and location 2 would be the exposure location 1602 immediately clockwise from location 1.

In an example, exposure locations 1602 at locations 14 through 17, locations 60 through 62, locations 89 through 91, and locations 136 through 138 can be skipped or omitted. The exposure locations 1602 can be located at angles from the positive direction y-axis (+Y) in ranges from about 30 degrees to about 39 degrees, from about 140 degrees to about 147 degrees, from about 210 degrees to about 217 degrees, and from about 323 degrees to about 330 degrees.

In another example, exposure locations 1602 at locations 24 through 25, locations 52 through 53, locations 99 through 101, and locations 127 through 128 can be skipped or omitted. The exposure locations 1602 can be located at angles from the positive direction y-axis (+Y) in ranges from about 54 degrees to about 59 degrees, from about 121 degrees to about 126 degrees, from about 234 degrees to about 241 degrees, and from about 301 degrees to about 306 degrees.

In these examples of omitting or skipping exposure locations 1602, the uniformity of the intensity of exposure can be increased (e.g., to having a variation lower than 1.78% rms). Other examples and patterns can omit or skip different exposure locations.

Referring back to the example of FIGS. 16A through 16C, imaging of a polygon was simulated to determine edge deviation of the resulting image from the original polygon. The original polygon to be imaged had a size that was approximately 10 pixels by 20 pixels in the array of the path centers. The original polygon had obtuse angles and an acute angle along the edges. After one full rotation of the convex reflective surface 112 and corresponding exposures at each of the 150 exposure locations 1602 (if such exposure locations 1602 are located within the polygon), a contour line of where accumulated energy dosage resulting from the exposures exceed 50% of a predefined dosage amount, which defines a resulting edge of an image, was obtained. Some corner rounding was observed in the contour line corresponding to corners or vertexes of the original polygon. Excluding such corner rounding, the observed edge placement shown by the contour line was within 0.04 pixels (of the array of the path centers) from the edge of the original polygon, and maintained a standard deviation of less than 1.5% of a pixel (of the array of the path centers).

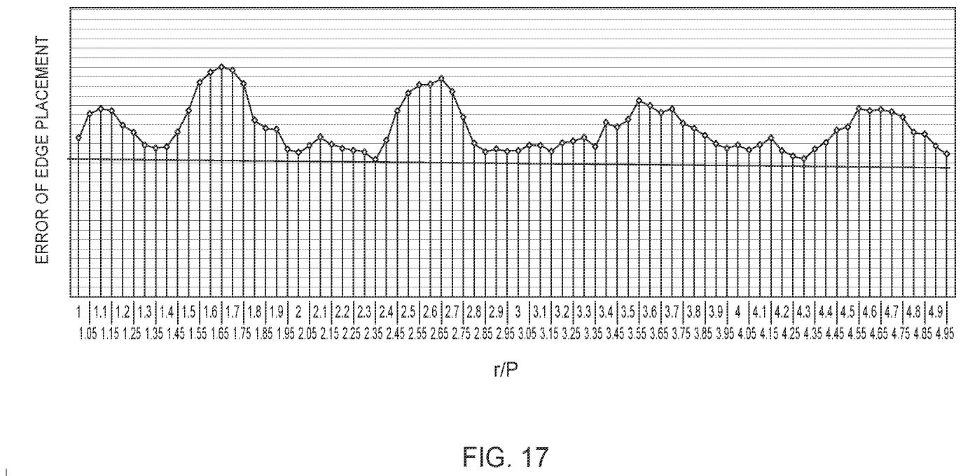

Edge deviation can depend on the ratio of the radius to the pitch (r/P) in examples like FIG. 16A through 16C. A number of simulations were performed to illustrate this dependency. In these examples, 80 exposure locations were distributed equally along each path. The ratio of the radius to the pitch (r/P) was different for each sample. After one full rotation of the convex reflective surface 112 and corresponding exposures at each of the 80 exposure locations (if such exposure locations are located within the polygon), a contour line was obtained for each sample. FIG. 17 is a graph showing the results of the samples, where error of edge placement of the imaged polygon relative to the original polygon is plotted versus the ratio of the radius to the pitch (r/P). Given the 80 exposure locations, some ratios of the radius to the pitch (r/P) were identified as having lower errors of edge deviation. These ratios included values at or near 1.35, 1.865, 1.95 to 2.35, 2.85 to 3.35, 4.3, and 4.95. It is contemplated that examples having different numbers of exposure locations along a path can have different ratios of the radius to the pitch (r/P) that have lower errors of edge deviation.

Additionally, binary projection, greyscale projection, and projection with different wavelengths can be implemented using an irregular address grid. The principles described above with respect to these projection techniques apply similarly to an irregular address grid, and hence, further description is omitted here.

Example Applications

The projection system and techniques described above can be applied to any application in which a static projection system is implemented, for example. In some examples, a resolution requirement for a projection system can be large, and a field size of the pixelated light source 102 (e.g., a DMD in this example) is larger than the image to be obtained. For example, a large array DMD (such as having 4K×2K pixels) projecting 100 μm pixels would obtain a field size that is 400 mm×200 mm. If the size of the image to be obtained is less than 400 mm×200 mm, then a technique described herein to generate a fine pitch address grid and without scanning the pixelated light source 102 (e.g., a DMD in this example) may be implemented. Various examples below are described in the context of the pixelated light source 102 being a DMD; other examples can implement other light sources. Specific applications are described below, but other applications are within the scope of other examples.

3D Printing

Any number of permutations of aspects described above can be implemented for 3D printing. An orthogonal or irregular address grid, binary or greyscale imaging and/or projection, and single or multiple wavelengths of light can be implemented as described above.

Projecting the exposures with a DMD, the frame rate for binary images can be 10 kHz, which results in the cumulative time for 150 exposures being 15 milliseconds. This enables processing 67 design layers per second. This short process time makes the techniques described herein suitable for applications needing a rapid lithography exposure with sub-pixel edge placement accuracy from a static system, such as a continuous pull 3D printer (e.g., Carbon 3D). At 67 design layers per second, a 3D printer operating to a 5 μm design grid could therefore print at a Z-height velocity of 1.2 meters per hour. To achieve 5 μm X/Y edge placement accuracy, the DMD pixel size can be set to 125 μm, and the irregular address grid of FIG. 16C can enable edge placement control of 4% pixel, or 5 μm. A DMD with 2560 rows and 1600 columns projected upon a 3D printing photo-resin interface at 125 μm pixel size can create an image field that is 320 mm×200 mm, which can build at a volumetric productivity of 77 liters per hour. Different scenarios are shown in the table below.

| | Ex. (1) | Ex. (2) | Ex. (3) | Ex. (4) | Ex. (5) |
|---|---|---|---|---|---|
| 3D Part Design Grid (μm) | 50 | 20 | 10 | 5 | 5 |
| Z-layer thickness (μm) | 50 | 20 | 10 | 5 | 5 |
| X/Y Edge Placement Tolerance (μm) | 50 | 20 | 10 | 5 | 5 |
| Number of Exposures per Layer per Path | 150 | 150 | 150 | 150 | 80 |
| DMD Binary Frame Rate (frames per second) | 10,000 | 10,000 | 10,000 | 10,000 | 10,000 |
| Time for Design Layer (seconds) | 0.15 | 0.15 | 0.15 | 0.15 | 0.008 |
| Build Velocity in Z-direction (m/hr) | 12 | 4.8 | 2.4 | 1.2 | 2.25 |
| Pixel Size (μm) | 1250 | 500 | 250 | 125 | 100 |
| Minimum Feature Size (μm) | 1250 | 500 | 250 | 125 | 100 |
| Expected Surface Roughness (1-sigma) (μm) | 19 | 8 | 4 | 2 | 2 |
| DMD Rows | 2560 | 2560 | 2560 | 2560 | 4000 |
| DMD Columns | 1600 | 1600 | 1600 | 1600 | 2000 |
| Image Field X (m) | 3.2 | 1.28 | 0.64 | 0.32 | 0.4 |
| Image Field Y (m) | 2 | 0.8 | 0.4 | 0.2 | 0.2 |
| Volumetric Productivity (m³/hr) | 76.80 | 4.92 | 0.61 | 0.08 | 0.18 |

Lithography

Any number of permutations of aspects described above can be implemented for lithography. An orthogonal or irregular address grid, binary or greyscale imaging and/or projection, and single or multiple wavelengths of light can be implemented as described above. The example below is described to further illustrate aspects concerning different responses in a photosensitive material from different wavelengths of light.

As shown by FIG. 16C, taking 150 shots along a circular path with a ratio r/P in the range of about 1 to about 5 creates a condition where successive shots along a path are mostly overlapping. In some applications, a two color exposure may be desirable because a photosensitive material (e.g., a photo-resin) may have different properties of response to different wavelengths. To accomplish two color lithography, the pixelated light source can implement alternating color for successive exposure frames (e.g., successive exposure locations along a path). The 150 exposures can be divided into alternating wavelength exposures where 75 exposures are for one color and 75 are for another color, or can be increased to 300 exposures per path yielding 150 exposures of each color. With a rasterizer engine that is separately computing the two color image, in-situ 2-color geometry lithography can be performed where each color has similar performance as described above with respect to FIG. 17.

Video Projection

In digital Cinema, the resolution of the screen is generally limited to the array size of the projector DMD; for example, the Texas Instruments Cinema 4K DMD has an array size of 4096×2160. Considering the case of FIG. 9B, by projecting a TI Cinema 4K DMD through a rotating Offner relay with an r/P ratio of 0.793, a reduced address grid can be obtained. The address grid can have a resolution that is two times greater than the TI Cinema 4K DMD, or can have a pitch that is half the pitch of pixels of the TI Cinema 4K DMD. An image that is 8192×4320 with a two times redundancy can be obtained. In the case of FIG. 10B, an image that is 5793×3055 with four times redundancy can be obtained.

To obtain three colors (e.g., red, green, and blue), three DMDs can be implemented where each DMD is projecting one color of either red, green, or blue, or the circular rotations of the convex reflective surface 112 can be at 10,080 revolutions per minute (RPM), which enables three colors (e.g., red, green, and blue) each having 8-bit levels of greyscale at 28 frames per second.

While the foregoing is directed to examples of the present disclosure, other and further examples of the disclosure may be devised without departing from the basic scope thereof, and the scope thereof is determined by the claims that follow.

What is claimed is:

1. A system comprising:
a pixelated light source comprising an array of spatial light modulator pixels, each spatial light modulator pixel being individually controllable to selectively project a beam of light; and
an optical relay comprising:
an optically reflective surface; and
an actuator coupled to the optically reflective surface, the actuator being configured to move the optically reflective surface,
wherein the pixelated light source and the optical relay are configured such that one or more beams projected from the pixelated light source are reflected off of the optically reflective surface and form an image of the optical relay in a focal plane, and wherein movement of the optically reflective surface causes the respective beams to be at varying locations in the focal plane.

2. The system of claim 1, wherein the optically reflective surface is a convex optically reflective surface, the actuator being configured to rotate the convex optically reflective surface.

3. The system of claim 2, wherein the convex optically reflective surface is attached at an attachment point to an axle of the actuator at a non-zero angle relative to an axis normal to a tangential surface of the convex optically reflective surface at the attachment point.

4. The system of claim 1 further comprising a controller communicatively coupled to the actuator and the pixelated light source, the controller being configured to control the actuator and to control the spatial light modulator pixels to selectively project or not project respective beams from the pixelated light source, wherein:
movement of the optically reflective surface causes each of the beams to be capable of being incident along a respective circular path in the focal plane; and
the controller is configured to control the actuator and the pixelated light source based on one or more bitmaps generated based on an address grid, the address grid being populated by address points corresponding to exposure locations along the circular paths.

5. The system of claim 4, wherein:
the address grid is an orthogonal address grid;
a pitch is between neighboring pairs of centers of the circular paths;
a radius is defined between each of the centers and the respective circular path; and
a ratio of the radius to the pitch is approximately 0.714.

6. The system of claim 4, wherein:
the address grid is an orthogonal address grid;
a pitch is between neighboring pairs of centers of the circular paths;
a radius is defined between each of the centers and the respective circular path; and
a ratio of the radius to the pitch is approximately 1.

7. The system of claim 4, wherein:
the address grid is an orthogonal address grid;
a pitch is between neighboring pairs of centers of the circular paths;
a radius is defined between each of the centers and the respective circular path; and
a ratio of the radius to the pitch is approximately 0.791.

8. The system of claim 4, wherein:
the address grid is an orthogonal address grid;
a pitch is between neighboring pairs of centers of the circular paths;
a radius is defined between each of the centers and the respective circular path; and
a ratio of the radius to the pitch is approximately 1.118.

9. The system of claim 4, wherein:
the address grid is an irregular address grid;
a pitch is between neighboring pairs of centers of the circular paths;
a radius is defined between each of the centers and the respective circular path; and
a ratio of the radius to the pitch is selected from the group consisting of approximately 1.35, approximately 1.865, within a range from 1.95 to 2.35, within a range from 2.85 to 3.35, approximately 4.3, and approximately 4.95.

10. The system of claim 4, wherein each of the address points corresponds to a respective exposure location along a respective circular path of at least two separate ones of the beams.

11. A method comprising:
moving a convex optically reflective surface;
projecting one or more beams from a pixelated light source based on a position of the convex optically reflective surface; and
reflecting the one or more beams off of the convex optically reflective surface towards a target, wherein movement of the convex optically reflective surface varies respective one or more angles of reflection of the one or more beams reflected off of the convex optically reflective surface.

12. The method of claim 11, wherein reflecting the one or more beams off of the convex optically reflective surface forms a binary image in a focal plane.

13. The method of claim 11, wherein the one or more beams includes multiple beams, each beam of the multiple beams has a same dose.

14. The method of claim 11, wherein reflecting the one or more beams off of the convex optically reflective surface forms a greyscale image in a focal plane.

15. The method of claim 11, wherein the one or more beams includes multiple beams, each beam of the multiple beams has a dose controlled to be one of multiple different doses.

16. The method of claim 11, wherein the one or more beams includes multiple beams, the multiple beams having multiple wavelengths of light.

17. A non-transitory storage medium storing instructions that, when executed by a processor, cause the processor to perform operations comprising:
controlling movement of an actuator, the actuator being connected to a convex optically reflective surface;
receiving positional information of the convex optically reflective surface from an encoder; and
controlling a pixelated light source to selectively project one or more beams based on the positional information, the one or more beams being incident on the convex optically reflective surface, movement of the convex optically reflective surface varying respective one or more angles of reflection of the one or more beams reflected off of the convex optically reflective surface.

18. The non-transitory storage medium of claim 17, wherein:
movement of the actuator causes each of the beams to be capable of being incident along a respective circular path in a focal plane;
the actuator and the pixelated light source are controlled based on one or more bitmaps generated based on an address grid, the address grid being populated by address points corresponding to exposure locations along the circular paths; and
the address grid is an orthogonal address grid having a same resolution as the pixelated light source, the orthogonal address grid having redundancy.

19. The non-transitory storage medium of claim 17, wherein:
movement of the actuator causes each of the beams to be capable of being incident along a respective circular path in a focal plane;
the actuator and the pixelated light source are controlled based on one or more bitmaps generated based on an address grid, the address grid being populated by address points corresponding to exposure locations along the circular paths; and
the address grid is an orthogonal address grid having a greater resolution than the pixelated light source.

20. The non-transitory storage medium of claim 17, wherein:
movement of the actuator causes each of the beams to be capable of being incident along a respective circular path in a focal plane;
the actuator and the pixelated light source are controlled based on one or more bitmaps generated based on an address grid, the address grid being populated by address points corresponding to exposure locations along the circular paths; and
the address grid is a non-orthogonal address grid comprising address points along the circular paths of the beams, the circular paths being overlapping.
